(19) United States
(12) Patent Application Publication
(10) Pub. No.: US 2022/0204793 A1
(43) Pub. Date: Jun. 30, 2022

(54) Ink Set And Recording Apparatus

(71) Applicant: Seiko Epson Corporation, Tokyo (JP)

(72) Inventors: Manabu TANIGUCHI, Shiojiri (JP); Hiroaki KUMETA, Matsumoto (JP); Soichi YAMAZAKI, Shiojiri (JP); Yoshifumi HANO, Matsumoto (JP); Shunsuke UCHIZONO, Shiojiri (JP)

(21) Appl. No.: 17/560,550

(22) Filed: Dec. 23, 2021

(30) Foreign Application Priority Data
Dec. 24, 2020 (JP) 2020-215470

(51) Int. Cl. C09D 11/40; C09D 11/324; C09D 11/328; C09D 11/38; C09D 11/033; C08K 3/36; C08K 5/17; B41M 5/00; B41J 2/045

(52) U.S. Cl. CPC C09D 11/40; C09D 11/324; C09D 11/328; C09D 11/38; B41J 2/04586; C08K 3/36; C08K 5/175; B41M 5/0023; C09D 11/033

(57) ABSTRACT

An ink set including at least one first ink composition and at least one second ink composition, wherein the first ink composition contains a pigment, an inorganic oxide colloid, and water, the second ink composition contains a dye and water, and in the ink set, an arithmetic mean of a conductivity of the at least one first ink composition at 25° C. and a conductivity of the at least one second ink composition at 25° C. is 2.5 mS/cm or less.

The present application is based on, and claims priority from JP Application Serial Number 2020-215470, filed Dec. 24, 2020, the disclosure of which is hereby incorporated by reference herein in its entirety.

### BACKGROUND

### 1. Technical Field

The present disclosure relates to an ink set and a recording apparatus.

### 2. Related Art

An ink jet recording method can record a high-definition image by using a relatively simple apparatus and has been rapidly developed in various fields. In this regard, stacking performance during high-speed paper transportation and the like have also been variously researched. For example, JP-A-2020-007444 discloses that stacking performance is improved by using an ink jet recording ink containing a pigment, colloidal silica, and an amino acid.

Incidentally, in an ink jet recording apparatus, a pigment ink and a dye ink may be ejected from the same ink jet head. Regarding such a recording method, it was found that a liquid-repellent film of a nozzle-formed surface readily deteriorated due to the use of an ink containing an inorganic oxide colloid such as colloidal silica as a pigment ink and repeated recording and cleaning of the nozzle-formed surface.

### SUMMARY

The present disclosure is an ink set including at least one first ink composition and at least one second ink composition, wherein the first ink composition contains a pigment, an inorganic oxide colloid, and water, the second ink composition contains a dye and water, and in the ink set, an arithmetic mean of a conductivity of the at least one first ink composition at 25° C. and a conductivity of the at least one second ink composition at 25° C. is 2.5 mS/cm or less.

In addition, the present disclosure is a recording apparatus that uses the above-described ink set and that is provided with an ink jet head including, at a nozzle-formed surface, a first nozzle array to eject a first ink composition and a second nozzle array to eject a second ink composition and a wiping member to wipe an opening of the first nozzle array and an opening of the second nozzle array.

### BRIEF DESCRIPTION OF THE DRAWINGS

FIG. 1 is a perspective view illustrating an example of a recording apparatus according to the present embodiment.

FIG. 2 is a plan view illustrating a nozzle-formed surface of an ink jet head according to the present embodiment.

### DESCRIPTION OF EXEMPLARY EMBODIMENTS

The embodiment according to the present disclosure (hereafter referred to as “the present embodiment”) will be described below in detail with reference to the drawings, as the situation demands. However, the present disclosure is not limited to this and can be variously modified within the bounds of not departing from the scope of the disclosure. In this regard, in the drawings, the same elements are indicated by the same references and duplicate explanations may be omitted. The positional relationship in the vertical direction, the horizontal direction, or the like is in accord with the positional relationship illustrated in the drawings, unless otherwise specified. Further, the dimensional ratios of the drawings are not limited to the ratios illustrated in the drawings.

### 1. Ink Set

An ink set according to the present embodiment is configured to include at least one first ink composition containing a pigment, an inorganic oxide colloid, and water and at least one second ink composition containing a dye and water, where, in the ink set, an arithmetic mean of a conductivity of the at least one first ink composition at 25° C. and a conductivity of the at least one second ink composition at 25° C. is 2.5 mS/cm or less.

It was found that when an ink jet head including a nozzle to eject a pigment ink containing an inorganic oxide colloid and a nozzle to eject a dye ink is subjected to cleaning through wiping or the like, the inorganic oxide colloid aggregates due to mixing of the pigment ink and the dye ink, and the inorganic oxide colloid aggregate damages a liquid-repellent film and the like of a nozzle plate.

On the other hand, in the present embodiment, the arithmetic mean of the conductivity of the first ink composition and the conductivity of the second ink composition being set to be within a predetermined range enables such aggregation to be suppressed from occurring and enables the wiping durability to be improved.

From such a viewpoint, the arithmetic mean of the conductivity S₁ of the first ink composition at 25° C. and the conductivity S₁ of the at least one second ink composition at 25° C. is 2.5 mS/cm or less, preferably from 0.5 to 2.3 mS/cm, more preferably from 0.5 to 2.1 mS/cm, and further preferably from 0.5 to 1.9 mS/cm. In this regard, the ink set according to the present embodiment may include a plurality of first ink compositions and a plurality of second ink compositions, and the above-described arithmetic mean is specified to be an arithmetic mean of the conductivity of each of the first ink compositions and each of the second ink compositions contained in the ink set.

Regarding an ink used in combination with a treatment liquid, component design is performed with an intention of causing aggregation. However, as described above, it is intended that the ink contained in the ink set according to the present embodiment avoid aggregation. Therefore, it is preferable that the ink set according to the present embodiment be an ink set not provided with a treatment liquid that aggregates ink components, such as an inorganic oxide colloid or the like. The composition of each of the ink compositions will be described below in detail.

### 1.1. First Ink Composition

The first ink composition contains a pigment, an inorganic oxide colloid, and water and may contain, as the situation demands, an amino acid, a pH regulator, a water-soluble organic solvent, and a surfactant.

### 1.1.1. Inorganic Oxide Colloid

Using the inorganic oxide colloid reduces wetting friction of a print surface due to an effect of the spherical inorganic oxide colloid so as to improve the stacking performance of a recorded material and, in addition, suppresses a recorded material from curling and cockling due to hygroscopicity and the like of the inorganic oxide colloid. Consequently, recorded materials can be accurately stacked even when high-speed paper transportation is performed. Further, a pigment readily remains on a recording medium due to a filling effect of the inorganic oxide colloid, and the color developability of the resulting recorded material is further improved.

Herein, “inorganic oxide colloid” denotes the state of fine particles of SiO₂, Al₂O₃, or the like being dispersed in a dispersion medium, and, in the present embodiment, “an ink contains an inorganic oxide colloid” denotes inorganic oxide fine particles being in the dispersion state in which a solvent constituting the ink serves as a dispersion medium.

There is no particular limitation regarding the inorganic oxide colloid, and examples include colloidal silica and an alumina colloid. Of these, colloidal silica is preferable. Using such an inorganic oxide colloid further improves the color developability of the resulting recorded material and further suppresses curling and cockling from occurring so that high-speed transportation of the recording medium can be performed. The colloidal silica tends to be suppressed from precipitating and accordingly has further improved stability compared with dry silica, such as fumed silica, and tends to have excellent ejection stability since the viscosity of the ink jet ink is not readily increased even when the colloidal silica is contained. In addition, using such an inorganic oxide colloid and adjusting the conductivity tend to further improve the wiping durability and the ejection stability. The inorganic oxide colloid may be used alone, or at least two types may be used in combination.

Particles of the inorganic oxide colloid may be subjected to surface treatment. For example, the colloidal silica may be surface-treated with alumina. Consequently, the pH range in which the colloid can be stably dispersed tends to be expanded and the dispersion stability tends to be further improved.

From the viewpoint of the above-described stacking performance, it is preferable that the inorganic oxide colloid particle be substantially spherical, and it is preferable that a primary particle not take an associated shape such as a secondary particle shape.

Regarding the above-described colloidal silica, commercially available products may also be used. Examples include SNOWTEX 20, SNOWTEX 30, SNOWTEX 40, SNOWTEX 0, SNOWTEX N, and SNOWTEX C (all produced by “NISSAN CHEMICAL INDUSTRIES, LTD.”).

The average particle diameter of the inorganic oxide colloid is preferably from 5 to 150 nm, more preferably from 5 to 100 nm, and further preferably from 10 to 70 nm. When the average particle diameter is 150 nm or less, precipitation tends to be suppressed from occurring and the dispersion stability tends to be further improved. When the average particle diameter is 5 nm or more, the sliding friction of the print surface tends to be further improved, and the stacking performance tends to be further improved.

The average particle diameter of the colloidal silica can be measured by using a particle size distribution measuring apparatus where the measurement principle is a dynamic light scanning method. Examples of such a particle size distribution measuring apparatus include the “Zeta-potential⋅Particle size⋅Molecular weight Measurement System ELSZ-2000ZS” (trade name) produced by OTSUKA ELECTRONICS CO., LTD., in which a homodyne optical system is adopted as a frequency analyzing method. In this regard, in the present specification, “average particle diameter” denotes an average particle diameter on a number average basis, unless otherwise specified.

The content of the inorganic oxide colloid is preferably from 1.0% to 15% by mass, more preferably from 2.0% to 12% by mass, and further preferably from 3.0% to 10% by mass on a solids content basis relative to the total amount of the first ink composition. When the content of the inorganic oxide colloid is 0.5% by mass or more, the color developability of the resulting recorded material is further improved, and curling and cockling are further suppressed from occurring so that the transportation speed of the recording medium can be further increased. In addition, when the content of the inorganic oxide colloid is 15% by mass or less, the wiping durability and the stacking performance tend to be further improved.

### 1.1.2. Pigment

There is no particular limitation regarding the pigment, and examples of usable pigments include organic pigments such as azo pigments (including, for example, azo lakes, insoluble azo pigments, condensed azo pigments, and chelate azo pigments), polycyclic pigments (for example, phthalocyanine pigments, perylene pigments, perinone pigments, anthraquinone pigments, quinacridone pigments, dioxazine pigments, thioindigo pigments, isoindolinone pigments, and quinophthalone pigments), nitro pigments, nitroso pigments, and aniline black; inorganic pigments such as carbon black (for example, furnace black, thermal lamp black, acetylene black, and channel black), metal oxides, metal sulfides, and metal chlorides; and extender pigments such as calcium carbonate and talc. Of these, it is preferable that carbon black be contained.

The above-described pigment in the form of a pigment dispersion liquid obtained by dispersing the pigment in water with a dispersing agent or in the form of a pigment dispersion liquid obtained by dispersing, in water, a self-dispersion-type surface-treated pigment in which a hydrophilic group has been introduced on the pigment particle surface by exploiting a chemical reaction or a pigment dispersion liquid obtained by dispersing, in water, a pigment covered with a polymer may be added to an ink.

Each of the pigment and the dispersing agent constituting the pigment dispersion liquid may be used alone, or at least two types may be used in combination.

The content of the pigment is preferably from 1.0% to 12% by mass, more preferably from 2.0% to 10% by mass, and further preferably from 3.0% to 7.5% by mass on a solids content basis relative to the total amount of the first ink composition.

### 1.1.3. Water

The content of the water is preferably from 40% to 80% by mass, more preferably from 50% to 75% by mass, and further preferably from 60% to 70% by mass relative to the total amount of the first ink composition. When the content of the water is 50% by mass or more, even when a portion of the water is vaporized, the viscosity of the ink tends to be suppressed from increasing, and the ejection stability tends to be further improved. When the content of the water is 80% by mass or less, the resulting recorded material tends to be further suppressed from curling and cockling.

### 1.1.4. Amino Acid

The first ink composition may further contain an amino acid. The amino acid according to the present embodiment denotes a compound having an amino group and a carboxy group in the molecule. There is no particular limitation regarding such an amino acid, and examples include tertiary amino acids such as dimethylglycine, dimethylalanine, dimethylglutamic acid, and diethylglycine; and quaternary amino acids such as trimethylglycine, trimethylalanine, trimethylglutamic acid, and triethylglycine.

Of these, quaternary amino acids having a quaternary ammonium group are preferable, and trimethylglycine is more preferable. When such an amino acid is used, the wiping durability and the ejection stability tend to be further improved. In this regard, the amino acid may be used alone, or at least two types may be used in combination.

The content of the amino acid is preferably from 1.0% to 20% by mass, more preferably from 2.0% to 15% by mass, and further preferably from 3.0% to 10% by mass relative to the total amount of the first ink composition. The content of the amino acid being within the above-described range suppresses a hard aggregate from forming during aggregation of the inorganic oxide colloid and improves the dispersion stability of the inorganic oxide colloid. Therefore, the wiping durability and the ejection stability tend to be further improved.

Preferably, the content of the amino acid is more than the solids content of the inorganic oxide colloid on a mass basis. Specifically, the content of the amino acid is preferably from 1.1 to 5.0 times, more preferably from 1.2 to 3.0 times, and further preferably from 1.3 to 2.0 times the solids content of the inorganic oxide colloid on a mass basis. When the content of the amino acid is within the above-described range, the wiping durability and the ejection stability tend to be further improved.

### 1.1.5. pH Regulator

There is no particular limitation regarding the pH regulator, and examples include organic bases such as triethanolamine (pKa of 7.8), diethanolamine (pKa of 8.88), monoethanolamine (pKa of 9.55), and tripropanolamine (pKa of 8.06); and inorganic bases such as lithium hydroxide, sodium hydroxide, and potassium hydroxide.

Of these, organic bases are preferable, and triethanolamine is more preferable. Since use of such an organic base improves the dispersion stability of the inorganic oxide colloid, the wiping durability and the ejection stability tend to be further improved.

The pKa of the organic base at 25° C. is preferably from 7.2 to 10, more preferably from 7.2 to 9.5, and further preferably from 7.5 to 9.0. Since the pKa of the organic base at 25° C. being within the above-described range improves the dispersion stability of the inorganic oxide colloid, the wiping durability and the ejection stability tend to be further improved.

The content of the pH regulator is preferably from 0.05% to 1.5% by mass, more preferably from 0.10% to 1.0% by mass, and further preferably from 0.20% to 0.75% by mass relative to the total amount of the first ink composition. Since the content of the pH regulator being within the above-described range improves the dispersion stability of the inorganic oxide colloid, the wiping durability and the ejection stability tend to be further improved.

### 1.1.6. Water-Soluble Organic Solvent

There is no particular limitation regarding the water-soluble organic solvent, and examples include glycerin; glycols such as ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, and 1,6-hexanediol; glycol monoethers such as ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, triethylene glycol monomethyl ether, and triethylene glycol monobutyl ether; nitrogen-containing solvents such as 2-pyrrolidone, N-methyl-2-pyrrolidone, N-ethyl-2-pyrrolidone, and 1-(2-hydroxyethyl)-2-pyrrolidone; and alcohols such as methanol, ethanol, n-propyl alcohol, iso-propyl alcohol, n-butanol, 2-butanol, tert-butanol, iso-butanol, n-pentanol, 2-pentanol, 3-pentanol, and tert-pentanol.

Of these, glycerin, glycols such as triethylene glycol, glycol monoethers such as triethylene glycol monobutyl ether, and nitrogen-containing solvents such as 1-(2-hydroxyethyl)-2-pyrrolidone are preferable. When such a water-soluble organic solvent is used, the wiping durability and the ejection stability tend to be further improved. The water-soluble organic solvent may be used alone, or at least two types may be used in combination.

In particular, it is preferable that at least the nitrogen-containing solvent be contained as the water-soluble organic solvent. When the nitrogen-containing solvent is contained, the wiping durability tends to be further improved. The content of the nitrogen-containing solvent is preferably from 1.0% to 9.0% by mass, more preferably from 2.0% to 8.0% by mass, and further preferably from 3.0% to 7.0% by mass relative to the total amount of the first ink composition.

The content of the water-soluble organic solvent is preferably from 5.0% to 30% by mass, more preferably from 10% to 27.5% by mass, and further preferably from 15% to 25% by mass relative to the total amount of the first ink composition. When the content of the water-soluble organic solvent is within the above-described range, the wiping durability and the ejection stability tend to be further improved.

### 1.1.7. Surfactant

There is no particular limitation regarding the surfactant, and examples include acetylene-glycol-based surfactants, fluorine-based surfactants, and silicone-based surfactants. Of these, acetylene-glycol-based surfactants are preferable from the viewpoint of the wiping durability and the ejection stability. The surfactant may be used alone, or at least two types may be used in combination.

There is no particular limitation regarding the acetylene-glycol-based surfactant, and at least one selected from, for example, 2,4,7,9-tetramethyl-5-decyne-4,7-diol and 2,4,7,9-tetramethyl-5-decyne-4,7-diol alkylene oxide adducts, 2,4-dimethyl-5-decyn-4-ol, and 2,4-dimethyl-5-decyn-4-ol alkylene oxide adducts is preferable.

There is no particular limitation regarding the fluorine-based surfactant, and examples include perfluoroalkyl sulfonic acid salts, perfluoroalkyl carboxylic acid salts, perfluoroalkyl phosphoric acid esters, perfluoroalkyl ethylene oxide adducts, perfluoroalkyl betaine, and perfluoroalkyl amine oxide compounds.

Examples of the silicone-based surfactant include polysiloxane-based compounds and polyether-modified organosiloxanes.

The content of the surfactant is preferably from 0.1% to 5.0% by mass and more preferably from 0.1% to 3.0% by mass relative to the total amount of the first ink composition. When the content of the surfactant is within the above-described range, the wiping durability and the ejection stability tend to be further improved.

### 1.1.8. Conductivity at 25° C.

The conductivity at 25° C. of the first ink composition is preferably from 0.8 to 2.3 mS/cm, more preferably from 1.0 to 2.0 mS/cm, and further preferably from 1.0 to 1.8 mS/cm. When the conductivity at 25° C. is within the above-described range, the wiping durability and the ejection stability tend to be further improved.

There is no particular limitation regarding the method for measuring the conductivity, and the measurement can be performed by using, for example, an ES-51 conductivity meter produced by HORIBA, Ltd. The conductivity of an ink can be adjusted by adjusting the amount of ions included in the ink. Ions may be optionally added to the ink and may also be mixed into the ink with a pigment and an inorganic oxide colloid. Ions mixed into the ink are changed in accordance with the types of the pigment and the inorganic oxide colloid and the amount of addition. Therefore, the conductivity can be adjusted by removing ions through a dialysis membrane.

1.1.9. pH

The pH of the first ink composition is preferably from 8 to 10 and more preferably from 8.5 to 9.5. Since the pH being within the above-described range improves the dispersion stability of the inorganic oxide colloid and suppresses an aggregate from being formed, the wiping durability and the ejection stability tend to be further improved.

### 1.1.10. Amount of Ions

The total concentration of Na ions and K ions in the first ink composition is preferably from 110 to 750 ppm, more preferably from 150 to 500 ppm, and further preferably from 200 to 400 ppm. Since the total concentration of Na ions and K ions being within the above-described range improves the dispersion stability of the inorganic oxide colloid, the wiping durability and the ejection stability tend to be further improved.

### 1.2. Second Ink Composition

The second ink composition contains a dye and water and may contain, as the situation demands, a pH regulator, a water-soluble organic solvent, and a surfactant.

### 1.2.1. Dye

There is no particular limitation regarding the dye, and examples include acidic dyes such as C.I. Acid Yellow, C.I. Acid Red, C.I. Acid Blue, C.I. Acid Orange, C.I. Acid Violet, and C.I. Acid Black; basic dyes such as C.I. Basic Yellow, C.I. Basic Red, C.I. Basic Blue, C.I. Basic Orange, C.I. Basic Violet, and C.I. Basic Black; direct dyes such as C.I. Direct Yellow, C.I. Direct Red, C.I. Direct Blue, C.I. Direct Orange, C.I. Direct Violet, and C.I. Direct Black; reactive dyes such as C.I. Reactive Yellow, C.I. Reactive Red, C.I. Reactive Blue, C.I. Reactive Orange, C.I. Reactive Violet, and C.I. Reactive Black; and disperse dyes such as C.I. Disperse Yellow, C.I. Disperse Red, C.I. Disperse Blue, C.I. Disperse Orange, C.I. Disperse Violet, and C.I. Disperse Black. The above-described dye may be used alone, or at least two types may be used in combination.

### 1.2.2. Water

The content of the water is preferably from 45% to 85% by mass, more preferably from 55% to 80% by mass, and further preferably from 65% to 75% by mass relative to the total amount of the second ink composition. When the content of the water is 55% by mass or more, even when a portion of the water is vaporized, the viscosity of the ink tends to be suppressed from increasing, and the ejection stability tends to be further improved. When the content of the water is 85% by mass or less, the resulting recorded material tends to be further suppressed from curling and cockling.

### 1.2.3. pH Regulator

Examples of the pH regulator may include materials akin to those listed in the first ink composition above. Of these, organic bases are preferable, and triethanolamine is more preferable. When such an organic base is used, the wiping durability and the ejection stability tend to be further improved.

The content of the pH regulator is preferably from 0.05% to 0.60% by mass, more preferably from 0.10% to 0.50% by mass, and further preferably from 0.20% to 0.40% by mass relative to the total amount of the second ink composition. When the content of the pH regulator is within the above-described range, the wiping durability and the ejection stability tend to be further improved.

### 1.2.4. Water-Soluble Organic Solvent

Examples of the water-soluble organic solvent may include materials akin to those listed in the first ink composition above. Of these, glycerin, glycols such as triethylene glycol, glycol monoethers such as triethylene glycol monobutyl ether, and nitrogen-containing solvents such as 1-(2-hydroxyethyl)-2-pyrrolidone are preferable.

In particular, it is preferable that at least the nitrogen-containing solvent be contained as the water-soluble organic solvent. Such a nitrogen-containing solvent being contained improves the solubility of the dye and enables the viscosity of a mixture when the pigment ink and the dye ink are mixed on the wiping member to be reduced. Consequently, the wiping durability tends to be further improved compared with a viscous liquid mixture with an aggregate rubbing a liquid-repellent film. The content of the nitrogen-containing solvent is preferably from 1.0% to 9.0% by mass, more preferably from 2.0% to 8.0% by mass, and further preferably from 3.0% to 7.0% by mass relative to the total amount of the second ink composition.

The content of the water-soluble organic solvent is preferably from 10% to 35% by mass, more preferably from 15% to 30% by mass, and further preferably from 20% to 27.5% by mass relative to the total amount of the second ink composition. When the content of the water-soluble organic solvent is within the above-described range, the wiping durability and the ejection stability tend to be further improved.

### 1.2.5. Surfactant

Examples of the surfactant may include materials akin to those listed in the first ink composition above. Of these, acetylene-glycol-based surfactants are preferable. When such a surfactant is used, the wiping durability and the ejection stability tend to be further improved.

The content of the surfactant is preferably from 0.1% to 5.0% by mass and more preferably from 0.1% to 3.0% by mass relative to the total amount of the second ink composition. When the content of the surfactant is within the above-described range, the wiping durability and the ejection stability tend to be further improved.

### 1.2.6. Conductivity at 25° C.

The conductivity at 25° C. of the second ink composition is preferably from 1.0 to 3.2 mS/cm, more preferably from 1.2 to 3.0 mS/cm, and further preferably from 1.4 to 2.8 mS/cm. When the conductivity at 25° C. is within the above-described range, the wiping durability and the ejection stability tend to be further improved.

The measuring method and the adjusting method of the conductivity may be akin to the methods described in the first ink composition.

1.2.7. pH

The pH of the second ink composition is preferably from 8.0 to 9.5 and more preferably from 8.4 to 9.3. Since the pH being within the above-described range suppresses an aggregate from being formed, the wiping durability and the ejection stability tend to be further improved.

### 2. Recording Apparatus

The recording apparatus according to the present embodiment is a recording apparatus that uses the above-described ink set and that is provided with an ink jet head including, at a nozzle-formed surface, a first nozzle array to eject the first ink composition and a second nozzle array to eject the second ink composition and a wiping member to wipe an opening of the first nozzle array and an opening of the second nozzle array.

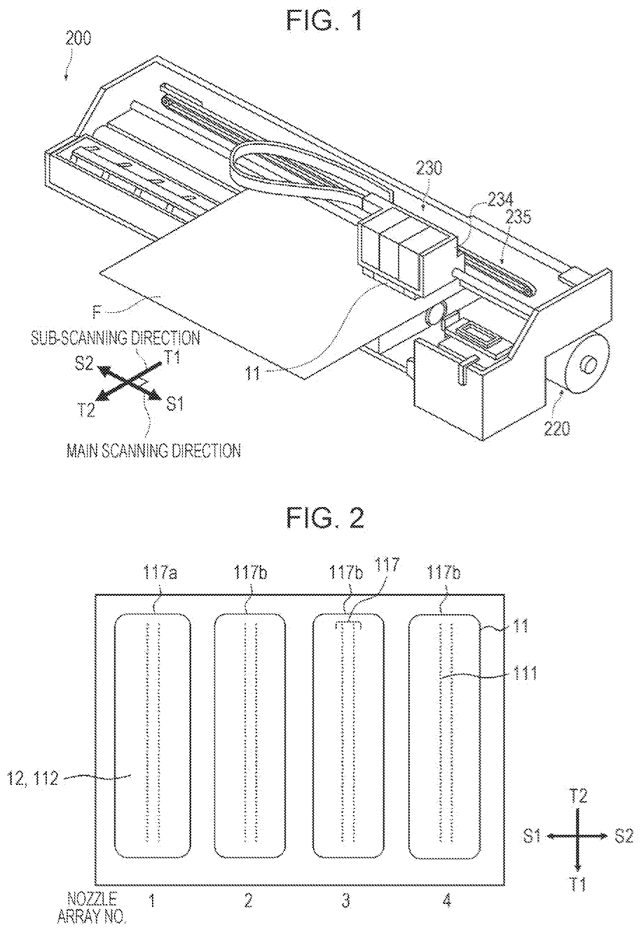

FIG. 1 is a perspective view illustrating a serial printer as an example of the recording apparatus according to the present embodiment. As illustrated in FIG. 1, a serial printer 200 includes a transport portion 220 and a recording portion 230. The transport portion 220 transports a recording medium F fed to the serial printer to the recording portion 230 and discharges the recording medium after recording to outside the serial printer. Specifically, the transport portion 220 have feed rollers and transports the fed recording medium F in the sub-scanning direction T2.

The recording portion 230 includes an ink jet head 11 to eject the ink composition to the recording medium F fed from the transport portion 220, a carriage 234 equipped with the ink jet head 11, and a carriage movement mechanism 235 to move the carriage 234 in the main scanning directions S1 and S2 of the recording medium F.

### 2.1 Ink Jet Head

The ink jet head 11 includes a nozzle plate 112 having a plurality of openings 111 at the surface facing the recording medium (adhesion target), a plurality of pressure chambers (not illustrated in the drawing) in communication with the plurality of openings 111, respectively, formed in the nozzle plate 112, a pressurizing portion (not illustrated in the drawing) to change the volume of each of the plurality of pressure chambers, and a ink feed chamber (not illustrated in the drawing) to feed an ink to the plurality of pressure chambers.

In the present embodiment, the nozzle-formed surface 12 denotes a surface including the surface of the nozzle plate 112. FIG. 2 illustrates an example of the nozzle-formed surface 12 of the ink jet head 11. In the ink jet head 11 illustrated in FIG. 2, nozzle arrays 117 each having openings 111 formed side by side in the sub-scanning direction (transportation direction of the recording medium) intersecting the main scanning direction are formed.

In the present embodiment, the nozzle array 117 that ejects the first ink composition is denoted as a first nozzle array 117a, and the nozzle array 117 that ejects the second ink composition is denoted as a second nozzle array 117b. It is preferable that the openings 111 of the first nozzle array 117a and the openings 111 of the second nozzle array 117b be present at a single nozzle-formed surface 12. Regarding such an ink jet head 11, since a wiping member simultaneously wipes the openings 111 of the first nozzle array 117a and the openings 111 of the second nozzle array 117b, aggregation of the inorganic oxide colloid tend to occur. Therefore, the present disclosure is particularly useful.

As illustrated in FIG. 2, the number of each of the first nozzle array 117a and the second nozzle array 117b may be one or more. When a plurality of nozzle arrays are formed, the nozzle arrays may be configured to eject the same type of ink composition, or the nozzle arrays may be configured to eject their respective ink compositions that differ from each other in, for example, the coloring material.

It is preferable that the ink jet head 11 include a liquid-repellent film on the nozzle-formed surface 12. There is no particular limitation regarding the liquid-repellent film provided that the film has liquid repellency. For example, the liquid-repellent film can be formed by forming a molecular film of metal alkoxide having liquid repellency and, thereafter, performing drying treatment, annealing treatment, and the like. There is no particular limitation regarding the molecular film of metal alkoxide provided that the film has liquid repellency, and a monomolecular film of a metal alkoxide having a long-chain polymer group containing fluorine or a monomolecular film of a metal acid salt having a liquid-repellent group such as a long-chain polymer group containing fluorine is desirable.

There is no particular limitation regarding the metal alkoxide, and regarding the metal species thereof, for example, silicon, titanium, aluminum, and zirconium are used in general. Examples of the long-chain RF group include a perfluoroalkyl chain and a perfluoropolyether chain. Examples of the alkoxysilane having the long-chain RF group include silane coupling agents having a long-chain RF group. There is no particular limitation regarding the liquid-repellent film, and, for example, silane coupling agent (SCA) films and those described in Japanese Patent No. 4,424,954 may be used. In particular, a film having water repellency is denoted as a water-repellent film.

Since such a liquid-repellent film of the ink jet head 11 is readily scratched by an aggregated inorganic oxide colloid, the present disclosure is particularly useful.

### 2.2. Wiping Member

The wiping member to wipe the openings of the first nozzle array and the openings of the second nozzle array may be an absorptive member to absorb an ink composition or a nonabsorptive member such as a rubber wiper, and a nonabsorptive member is preferable.

### Examples

The present disclosure will be more specifically described below with reference to the examples and the comparative examples. The present disclosure is not limited to the following examples.

### 1. Preparation of Ink

Each component was placed into a mixture tank in accordance with the composition described in Table 1, mixing and agitation were performed, and filtration with a 5-μm membrane filter was performed so as to obtain the composition of each example. In this regard, the numerical value of each component of each example described in Table 1 is expressed in % by mass, unless otherwise specified. In Table 1, the numerical values of the inorganic oxide colloid and a pigment dispersion liquid indicate the solids content in % by mass.

In this regard, pigment ink compositions A1 to A4 correspond to the first ink composition, and dye ink compositions B1 to B6 correspond to the second ink composition.

TABLE 1

| | | Pigment ink composition | | | | | Dye ink composition | | | | | | |
|---|---|---|---|---|---|---|---|---|---|---|---|---|---|
| | | A1 | A2 | A3 | A4 | A5 | B1 | B2 | B3 | B4 | B5 | B6 | B7 |
| Pigment | black pigment | 5.0 | 5.0 | 5.0 | 5.0 | 5.0 | — | — | — | — | — | — | — |
| Inorganic | colloidal silica | 5.0 | 5.0 | 5.0 | 9.0 | — | — | — | — | — | — | — | — |
| oxide colloid | | | | | | | | | | | | | |
| Dye | cyan dye | — | — | — | — | — | 5.0 | 5.0 | 5.0 | 5.0 | — | — | — |
| | magenta dye | — | — | — | — | — | — | — | — | — | 4.0 | — | 6.5 |
| | yellow dye | — | — | — | — | — | — | — | — | — | — | 3.0 | — |
| pH regulator | potassium hydroxide (KOH) | — | — | — | — | — | 0.1 | — | — | — | — | — | 0.2 |
| | triethanolamine (TEA) | 0.5 | 0.5 | 0.5 | 0.5 | 0.5 | — | 0.3 | 0.3 | 0.3 | 0.3 | 0.3 | — |
| Amino acid | trimethylglycine | — | 3.0 | 8.0 | 8.0 | 3.0 | — | — | — | — | — | — | — |
| Water- | 2-pyrrolidone | — | — | — | — | — | — | — | 4.0 | — | — | — | — |
| soluble | 1-(2-hydroxyethyl)-2-pyrrolidone | 5.0 | 5.0 | 5.0 | 5.0 | 5.0 | — | — | — | 4.0 | 4.0 | 4.0 | — |
| organic | triethylene glycol monobutyl ether | 3.0 | 3.0 | 3.0 | 3.0 | 3.0 | 5.0 | 5.0 | 5.0 | 5.0 | 5.0 | 5.0 | 5.0 |
| solvent | glycerin | 5.0 | 5.0 | 5.0 | 5.0 | 5.0 | 8.0 | 8.0 | 8.0 | 8.0 | 8.0 | 8.0 | 8.0 |
| | triethylene glycol | 8.0 | 5.0 | 5.0 | 5.0 | 5.0 | 8.0 | 8.0 | 8.0 | 8.0 | 8.0 | 8.0 | 8.0 |
| Surfactant | OLFIN E1010 | 0.5 | 0.5 | 0.5 | 0.5 | 0.5 | 0.5 | 0.5 | 0.5 | 0.5 | 0.5 | 0.5 | 0.5 |
| | Surfynol 104 | 0.5 | 0.5 | 0.5 | 0.5 | 0.5 | 0.5 | 0.5 | 0.5 | 0.5 | 0.5 | 0.5 | 0.5 |
| Water | | 67.5 | 67.5 | 62.5 | 58.5 | 72.5 | 72.9 | 72.7 | 68.7 | 68.7 | 69.7 | 70.7 | 71.3 |
| Conductivity | conductivity (mS/cm) | 1.6 | 1.6 | 1.6 | 2 | 0.9 | 2.4 | 2.0 | 2.0 | 2.0 | 1.8 | 1.6 | 3.5 |
| Amount of | total concentration of Na ions and K | 260 | 262 | 261 | 380 | 100 | — | — | — | — | — | — | — |
| ions in | ions (ppm) | | | | | | | | | | | | |
| pigment ink | | | | | | | | | | | | | |
| pH | — | 9.0 | 9.0 | 8.8 | 8.9 | 8.8 | 9.3 | 8.7 | 8.7 | 8.7 | 8.8 | 8.6 | 9.6 |

Abbreviations and components of products used in Table 1 are as described below.

### Pigment

Black pigment (CAB-O-JET300 (produced by Cabot Corporation), solids content of 15%)

### Inorganic Oxide Colloid

Colloidal silica (ST-30L (Nissan Chemical Industries, Ltd.))

### Dye

Cyan dye (C.I. Direct Blue 108 lithium salt)

Magenta dye (C.I. Acid Red 57 lithium salt)

Yellow dye (C.I. Direct Yellow 12 lithium salt)

pH regulator

potassium hydroxide (KOH)

triethanolamine (TEA)

### Amino Acid

trimethylglycine

### Water-Soluble Organic Solvent

2-pyrrolidone

1-(2-hydroxyethyl)-2-pyrrolidone

triethylene glycol monobutyl ether

glycerin

triethylene glycol

### Surfactant

OLFIN E1010 (trade name, Air Products and Chemicals, Inc., acetylene-glycol-based surfactant)

Surfynol 104 (trade name, produced by Nissin Chemical Industry Co., Ltd., acetylene-glycol-based surfactant)

### 1.1. Conductivity

In Table 1, the conductivity was measured by using a conductivity meter ES-51 (produced by HORIBA, Ltd.). The measurement temperature was set to be 25° C.

### 1.2. Amount of Ions

The sodium ion concentration was measured by using a compact sodium ion meter LAQUAtwin <Na-11> (produced by HORIBA, Ltd.), and the potassium ion concentration was measured by using a compact potassium ion meter LAQUAtwin <K-11> (produced by HORIBA, Ltd.). Subsequently, the total concentration was determined from these measured values. Each measurement temperature was set to be 25° C.

1.3. pH

The pH of the ink composition was measured by using a benchtop pH meter (Model: F-72, maker: HORIBA, Ltd.). The measurement temperature was set to be 25° C.

### 2. Evaluation Method

### 2.1. Wiping Durability

An ink cartridge of PX-57050 (serial ink jet printer) produced by EPSON was filled with ink compositions combined as described in Table 2, and it was checked that the nozzle arrays could eject the respective ink compositions. In this regard, the configuration of the nozzle-formed surface of the ink jet head was as illustrated in FIG. 2, the ink compositions were introduced so that the respective ink compositions described in Table 2 were ejected from nozzle array Nos. 1 to 4. For example, in example 1, nozzle array Nos. 2 to 4 were made to eject the same dye ink B1.

After it was checked that each nozzle array could eject the ink composition, an operation of wiping the openings of each nozzle array by using a wiping member (rubber wiper) of the wiping mechanism was repeated three times. Subsequently, the wiping member to which the ink compositions adhered was left to stand under a predetermined condition so as to dry the ink compositions adhered to the wiping member and to obtain the wiping member to which dried ink compositions adhered. In this regard, the present evaluation was performed under each of three conditions of at 30° C. for 5 days, at 40° C. for 5 days, and at 40° C. for 10 days.

The sequence in which the wiping member to which the dried ink compositions adhered was used and the nozzle-formed surface was wiped was repeated 100 times. Thereafter, presence or absence of shift of application point and non-ejection of nozzle was checked with a nozzle check pattern. Subsequently, the wiping member to which dried ink compositions adhered was prepared again, the above-described 100 times of wiping sequence and check with the nozzle check pattern were repeated. At the time when shift of application point or non-ejection of nozzle was observed, repetition was stopped. In the present evaluation, shift of application point or non-ejection of nozzle being observed denotes a water-repellent film being damaged by wiping. The evaluation criteria are as described below.

### Condition 1: Standing Condition of 30° C. for 5 Days

AA: shift of application point or non-ejection of nozzle was observed when the number of times of wiping was 500 or more

A: shift of application point or non-ejection of nozzle was observed when the number of times of wiping was 300 or more and less than 500

B: shift of application point or non-ejection of nozzle was observed when the number of times of wiping was 200 or more and less than 300

C: shift of application point or non-ejection of nozzle was observed when the number of times of wiping was 100 or more and less than 200

D: shift of application point or non-ejection of nozzle was observed when the number of times of wiping was less than 100

### Condition 2: Standing Condition of 40° C. for 5 Days

AA: shift of application point or non-ejection of nozzle was observed when the number of times of wiping was 500 or more

A: shift of application point or non-ejection of nozzle was observed when the number of times of wiping was 300 or more and less than 500

B: shift of application point or non-ejection of nozzle was observed when the number of times of wiping was 200 or more and less than 300

C: shift of application point or non-ejection of nozzle was observed when the number of times of wiping was 100 or more and less than 200

D: shift of application point or non-ejection of nozzle was observed when the number of times of wiping was less than 100

### Condition 3: Standing Condition of 40° C. for 10 Days

AA: shift of application point or non-ejection of nozzle was observed when the number of times of wiping was 500 or more

A: shift of application point or non-ejection of nozzle was observed when the number of times of wiping was 300 or more and less than 500

B: shift of application point or non-ejection of nozzle was observed when the number of times of wiping was 200 or more and less than 300

C: shift of application point or non-ejection of nozzle was observed when the number of times of wiping was 100 or more and less than 200

D: shift of application point or non-ejection of nozzle was observed when the number of times of wiping was less than 100

### 2.2. Stacking Performance

An ink cartridge of LX-10000F (line ink jet printer) produced by EPSON was filled with ink compositions combined as described in Table 2, and it was checked that the nozzle arrays could eject the respective ink compositions. Thereafter, a solid pattern with Print Duty: 100% was printed on a recording medium (A4 sized Xerox P paper, copy paper produced by Fuji Xerox Co., Ltd., basis weight of 64 g/m², paper thickness of 88 μm) in an environment at a temperature of 25° C. and a humidity of 50% so as to obtain a printed material. In this regard, when the solid pattern was printed, a monochrome solid pattern was formed by alternately ejecting ink compositions introduced into nozzle array Nos. 1 and 4. This printing operation was repeated so as to perform printing successively, and the stacking performance was evaluated based on whether a paper jam occurred.

### Evaluation Criteria

A: paper jam did not occur when 50 sheets were printed successively

B: paper jam occurred when 30 or more and less than 50 sheets were printed successively

C: paper jam occurred when 15 or more and less than 30 sheets were printed successively

D: paper jam occurred when less than 15 sheets were printed successively

TABLE 2

| | | | Arithmetic | | | | | Stacking |
|---|---|---|---|---|---|---|---|---|
| | Nozzle | | mean of | | Wiping durability | | | performance |
| | array No. | Ink composition | conductivity | Wiping mechanism | condition 1 | condition 2 | condition 3 | condition 1 |
| Example 1 | 1 | pigment ink A1 | 2.2 | wiping portion only | B | B | B | B |
| | 2 | dye ink B1 | | | | | | |
| | 3 | | | | | | | |
| | 4 | | | | | | | |
| Example 2 | 1 | pigment ink A1 | 1.8 | wiping portion only | A | B | B | A |
| | 2 | | | | | | | |
| | 3 | | | | | | | |
| | 4 | dye ink B1 | | | | | | |
| Example 3 | 1 | pigment ink A1 | 1.7 | wiping portion only | AA | B | B | A |
| | 2 | | | | | | | |
| | 3 | | | | | | | |
| | 4 | dye ink B2 | | | | | | |
| Example 4 | 1 | pigment ink A4 | 1.8 | wiping portion only | A | B | B | A |
| | 2 | dye ink B5 | | | | | | |
| | 3 | dye ink B5 | | | | | | |
| | 4 | dye ink B6 | | | | | | |
| Example 5 | 1 | pigment ink A1 | 1.7 | wiping portion only | AA | A | B | A |
| | 2 | | | | | | | |
| | 3 | | | | | | | |
| | 4 | dye ink B3 | | | | | | |
| Example 6 | 1 | pigment ink A1 | 1.7 | wiping portion only | AA | A | B | A |
| | 2 | | | | | | | |
| | 3 | | | | | | | |
| | 4 | dye ink B4 | | | | | | |

TABLE 3

| | | | Arithmetic | | | | | Stacking |
|---|---|---|---|---|---|---|---|---|
| | Nozzle | | mean of | Wiping | Wiping durability | | | performance |
| | array No. | Ink composition | conductivity | mechanism | condition 1 | condition 2 | condition 3 | condition 1 |
| Example 7 | 1 | pigment ink A2 | 1.7 | rubber wiper | AA | AA | B | A |
| | 2 | | | | | | | |
| | 3 | | | | | | | |
| | 4 | dye ink B4 | | | | | | |
| Example 8 | 1 | pigment ink A3 | 1.7 | rubber wiper | AA | AA | A | A |
| | 2 | | | | | | | |
| | 3 | | | | | | | |
| | 4 | dye ink B4 | | | | | | |
| Example 9 | 1 | pigment ink A3 | 1.7 | rubber wiper | AA | AA | A | B |
| | 2 | dye ink B4 | | | | | | |
| | 3 | dye ink B5 | | | | | | |
| | 4 | dye ink B6 | | | | | | |
| Comparative | 1 | pigment ink A1 | 2.6 | rubber wiper | D | D | D | B |
| example 1 | 2 | pigment ink A1 | | | | | | |
| | 3 | dye ink B7 | | | | | | |
| | 4 | dye ink B7 | | | | | | |
| Comparative | 1 | pigment ink A5 | 2.0 | rubber wiper | AA | AA | AA | D |
| example 2 | 2 | dye ink B1 | | | | | | |
| | 3 | | | | | | | |
| | 4 | | | | | | | |

What is claimed is:

1. An ink set comprising:
at least one first ink composition; and
at least one second ink composition, wherein
the first ink composition contains a pigment, an inorganic oxide colloid, and water,
the second ink composition contains a dye and water, and
in the ink set, an arithmetic mean of a conductivity of the at least one first ink composition at 25° C. and a conductivity of the at least one second ink composition at 25° C. is 2.5 mS/cm or less.

2. The ink set according to claim 1, wherein
the conductivity of the first ink composition is from 0.8 to 2.3 mS/cm.

3. The ink set according to claim 1, wherein
the first ink composition further contains an amino acid.

4. The ink set according to claim 3, wherein
a content of the amino acid is more than a content of the inorganic oxide colloid on a mass basis.

5. The ink set according to claim 1, wherein
the content of the inorganic oxide colloid is from 1.0% to 15% by mass relative to a total amount of the first ink composition.

6. The ink set according to claim 1, wherein
a content of the water contained in the first ink composition is from 40% to 80% by mass relative to a total amount of the first ink composition.

7. The ink set according to claim 1, wherein
the pigment contains carbon black.

8. The ink set according to claim 1, wherein
the conductivity of the second ink composition is from 1.0 to 3.2 mS/cm.

9. The ink set according to claim 1, wherein
a pH of the second ink composition is from 8.0 to 9.5.

10. The ink set according to claim 1, wherein
the second ink composition further contains an organic base.

11. The ink set according to claim 1, wherein
the second ink composition further contains a water-soluble organic solvent.

12. The ink set according to claim 1, wherein
a treatment liquid is not included.

13. A recording apparatus using an ink set including at least one first ink composition and at least one second ink composition, the recording apparatus comprising:
an ink jet head including, at a nozzle-formed surface,
a first nozzle array to eject the first ink composition and
a second nozzle array to eject the second ink composition, and
a wiping member to wipe an opening of the first nozzle array and an opening of the second nozzle array, wherein
the first ink composition contains a pigment, an inorganic oxide colloid, and water,
the second ink composition contains a dye and water, and
in the ink set, an arithmetic mean of a conductivity of the at least one first ink composition at 25° C. and a conductivity of the at least one second ink composition at 25° C. is 2.5 mS/cm or less.

14. The recording apparatus according to claim 13, wherein
the ink jet head includes a liquid-repellent film at the nozzle-formed surface.

15. The recording apparatus according to claim 13 wherein
the opening of the first nozzle array and the opening of the second nozzle array are formed at the same nozzle-formed surface.
